(19) United States
(12) Patent Application Publication
(10) Pub. No.: US 2007/0130483 A1
(43) Pub. Date: Jun. 7, 2007

(54) Power supply apparatus

(75) Inventor: Chih-Chien Wu, Taoyuan Hsien (TW)

Correspondence Address: BIRCH STEWART KOLASCH & BIRCH, PO BOX 747, FALLS CHURCH, VA, 22040-0747, US

(73) Assignee: SANHAN TECHNOLOGY CORPORATION

(21) Appl. No.: 11/634,302

(22) Filed: Dec. 6, 2006

(30) Foreign Application Priority Data
Dec. 7, 2005 (TW) 094221252

(51) Int. Cl. G06F 1/00

(52) U.S. Cl. 713/300

(57) ABSTRACT

A power supply apparatus mainly includes a main body which holds all related elements. The main body has a power supply input end, at least two power supply output ends, a regulation means corresponding to each of the power supply output ends and a power conversion circuit located in the main body. The power supply input end is connected to city power to receive AC power which is transformed by the power conversion circuit to a power supply mode preset by the regulation means. The transformed power supply is transmitted to each of the power supply output ends to be delivered to an electronic device connecting to each of the power supply output ends.

### FIELD OF THE INVENTION

The present invention relates to a power supply apparatus and particularly to a power supply apparatus to provide DC power or power supply for electronic devices of varying voltages.

### BACKGROUND OF THE INVENTION

The general consumer electronic devices, aside from having batteries to provide electric power, usually include a power supply converter to be connected to an external AC/DC power source for the devices to be used for a prolonged period of time, or for charging the batteries. As the suppliers of the electronic devices mostly have their own electrical specifications, the power supply converter is not fully compatible or cannot support the electronic devices of different brands. Hence users have to carry a specific power supply converter on the road to provide electric power for a corresponding electronic device. It becomes a burden on the luggage and creates a lot of inconveniences during business trips or travel. It also frequently happens that many users in the same office use different types of notebook computers, and each user has to provide a dedicated power supply converter.

To remedy the aforesaid problems, a power supply converter or a connector coupled with an equipment end that is embedded with different resistors or pins has been introduced on the market to alter output voltage of the power supply converter by switching the resistance value, or resistor blades representing different voltage output values are inserted into the connector to form short circuit to alter the output voltage value. Those two types of approaches adopt a technique that alters or adjusts the output voltage of the power supply converter to make one power supply converter to support different electronic devices at the same time so that users can free from the trouble of carrying a plurality of converters. However, the approaches mentioned above still have drawbacks during operation or use, notably:

1. Take notebook computers for instance. The voltage applicable to the present notebook computers on the market, depending on different suppliers, includes at least 15V, 16V, 18V, 19V, 20V and 24V. To accommodate the mating resistors for all these six types or more of different voltages in the limited space of a connector is a huge challenge for connector manufacturers. To meet such a requirement the development cost is much higher. And consumers still cannot fully free from using an erroneous connector and result in faulty output voltage.

2. The power supply converter mentioned above can be used only by one set of electronic device at a given time period. In the event that multiple numbers of electronic devices have to be used and the voltages have to be transformed by the power supply converter at the same time, multiple sets of power supply converters still have to be prepared and carried.

3. Users have to keep and store resistor blades for different voltage output values. It is a big trouble. As the resistor blades are formed at a small size and easily get lost, it creates annoyance to busy users.

### SUMMARY OF THE INVENTION

In view of the aforesaid problems, the present invention aims to provide a power supply apparatus that has a main body to provide DC power or different voltages to meet power supply requirements of electronic devices.

The primary object of the present invention is to provide a power supply apparatus that has a main body to hold all related elements. The main body includes a power supply input end, at least two power supply output ends, a regulation means corresponding to each of the power output ends, and a power conversion circuit located in the main body. The power supply input end is connected to city power to provide AC power. Through the power conversion circuit the AC power is transformed to a desired power supply mode preset in the regulation means. The transformed power supply is delivered to the power output end to be transmitted to the electronic device connecting to the power supply output end.

Another object of the power supply apparatus of the invention is to include a power cord, a socket and a plug on the power supply input end. The socket can be coupled alternately with an AC plug or a DC connector. The power cord can be stored in the main body through a wire collector. The main body has an opening to allow the power cord to be pulled out to facilitate utilization and improve practicality.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the power supply apparatus of the invention.

FIG. 2 is a schematic view of the power supply apparatus of the invention.

FIG. 3 is a schematic view of the power supply apparatus of the invention in a use condition.

FIG. 4 is a perspective view of another embodiment of the power supply input end of the invention.

FIG. 5 is an exploded view of the socket and plug according to FIG. 4.

FIG. 6 is a schematic view of the socket and plug according to FIG. 4.

FIG. 7 is a schematic view of another embodiment of the power supply output ends of the invention in a use condition.

### DETAILED DESCRIPTION OF THE PREFERRED EMBODIMENTS

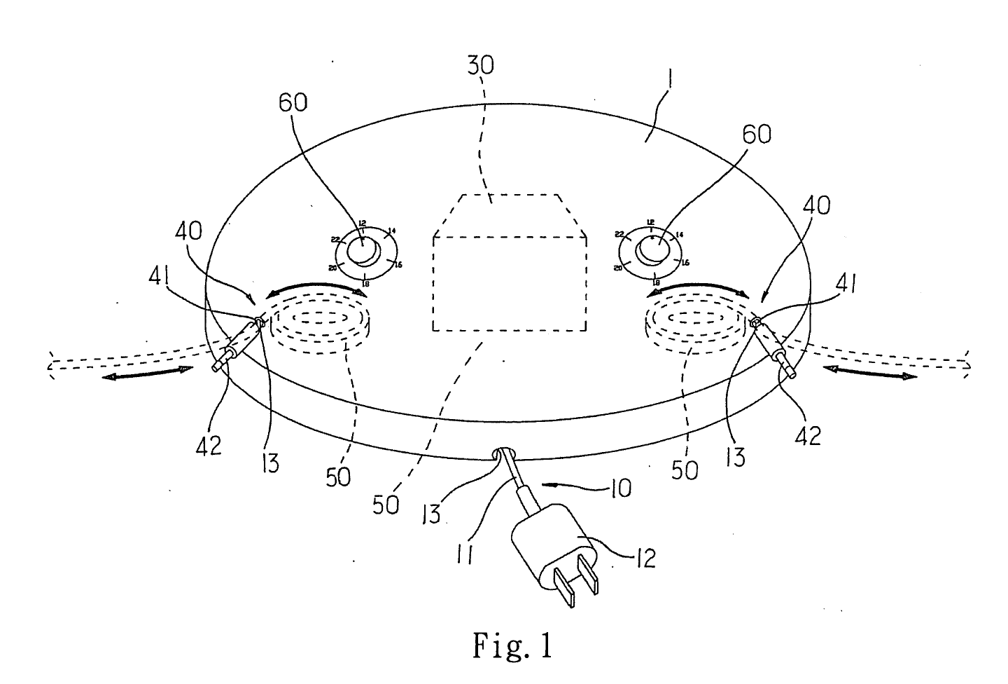

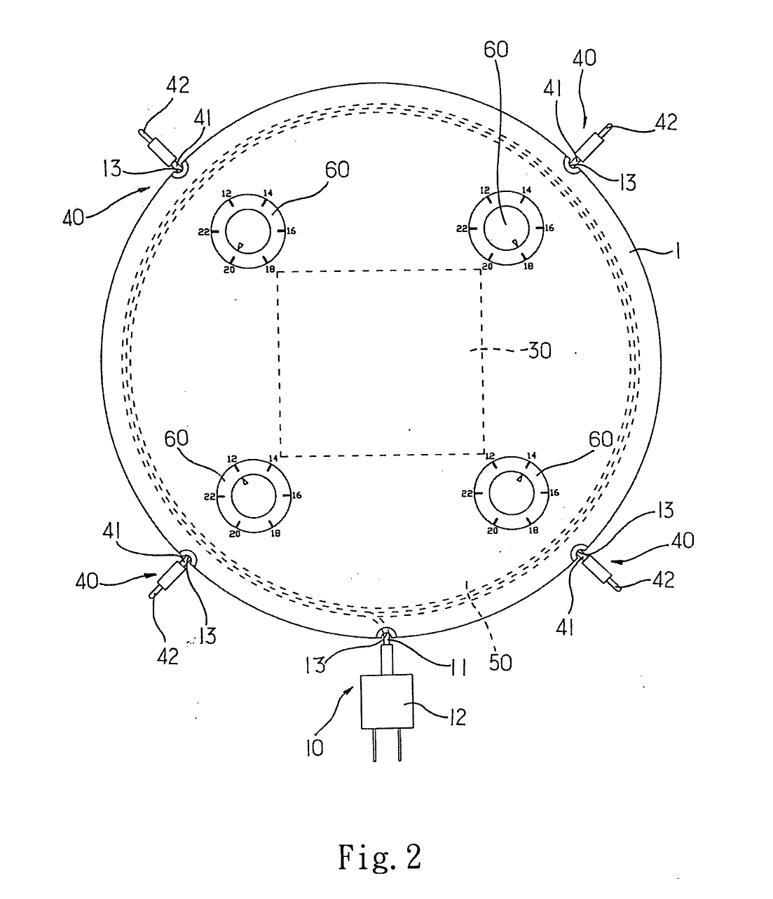

Please refer to FIGS. 1 and 2, the power supply apparatus according to the invention includes at least:

a main body 1 which holds all related elements;

at least one power supply input end 10 to receive power supply input. As an embodiment shown in the drawings, the power supply input end 10 has a first power cord 11 and a plug 12 to connect to a city power 20 to receive AC power, and transmit the power supply to a power conversion circuit 30. The first power cord 11 is stored in the main body 1 through a wire collector 50. The main body 1 has an opening 13 to allow the first power cord 11 to be pulled out;

the power conversion circuit 30 which is located in the main body 1 to transform the input power supply to a required power supply mode, such as transforming the input AC power to DC power, and delivering to power supply output ends 40;

at least two power supply output ends 40 connecting to other electronic devices to output the power supply to the corresponding electronic devices. Each of the power supply output ends 40 has a second power cord 41 and a DC connector 42. The second power cord 41 also is stored in the main body 1 through the wire collector 50. Another opening 13 is formed on the main body 1 to allow the second power cord 41 to be pulled out; and

a regulation means 60 corresponding to each of the power supply output ends 40 to regulate output power supply mode of the power supply output end 40, such as adjusting voltage values of the output power supply. For instance, the regulation means 60 may be formed like a rotary knob as shown in the drawings, and by adjusting the regulation means 60, varying output voltages can be obtained and delivered such as 3.3V. 5V, 7V, 9V, 12V, 15V, 16V, 18V, 19V, 20V, 24V, etc.

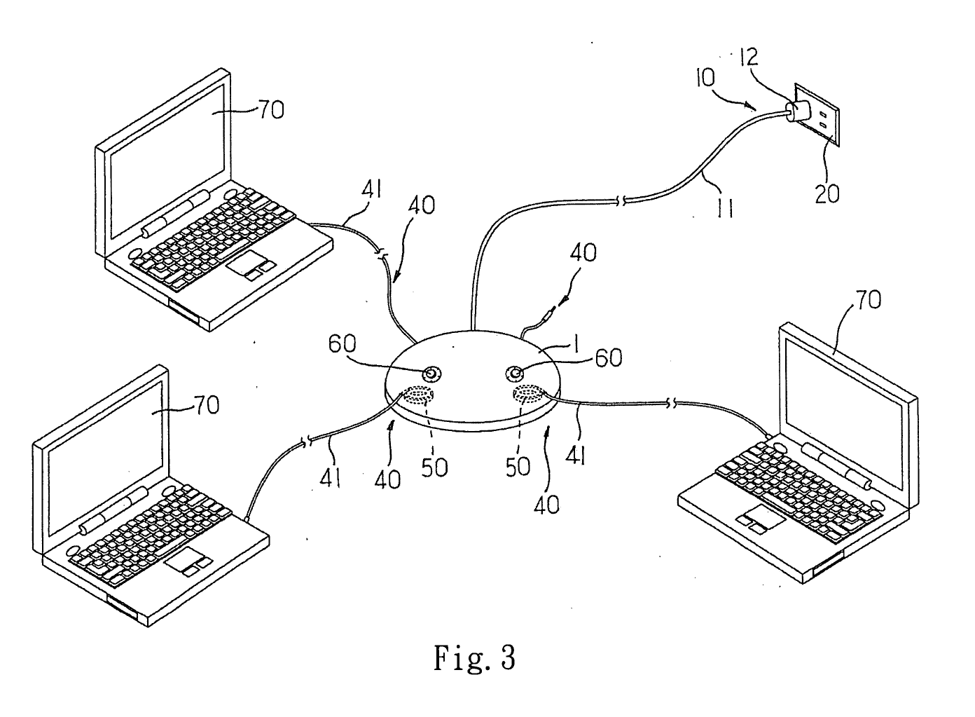

When in use, referring to FIG. 3, the plug 12 of the power supply input end 10 is connected to the city power 20 to have AC power transmitting to the main body 1 through the first power cord 11. The AC power is transformed by the power conversion circuit 30 to a desired power supply mode. In the event that the power output ends 40 are to be connected to electronic devices 70, as an embodiment shown in the drawing, the power supply output ends 40 may be connected to a plurality of notebook computers. As the power supply mode required by each of the notebook computers is DC power at a selected voltage which varies according to different brands, hence the regulation means 60 adjusts the voltage to a selected voltage, then the second power cord 41 of the power supply output end 40 may be pulled out to supply the power for the selected notebook computer.

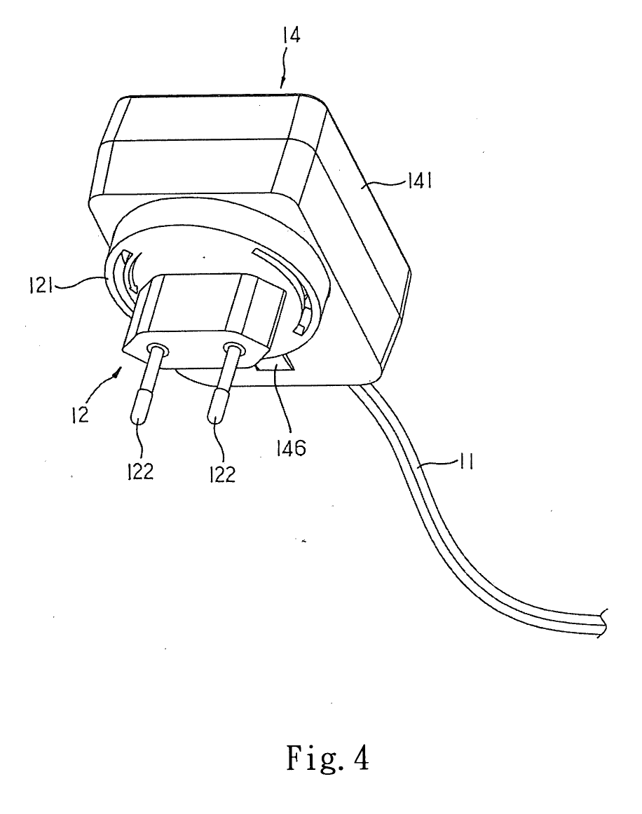

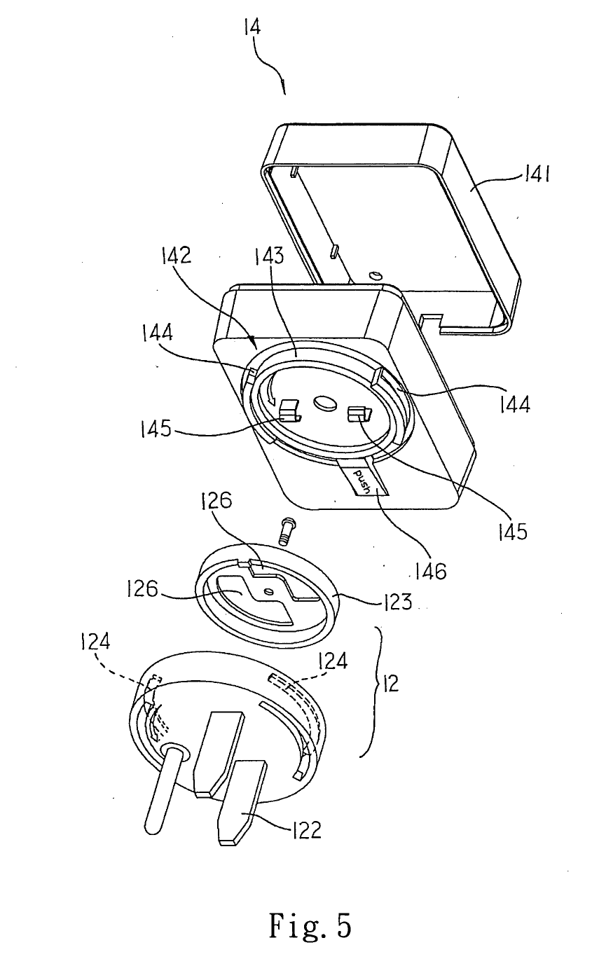

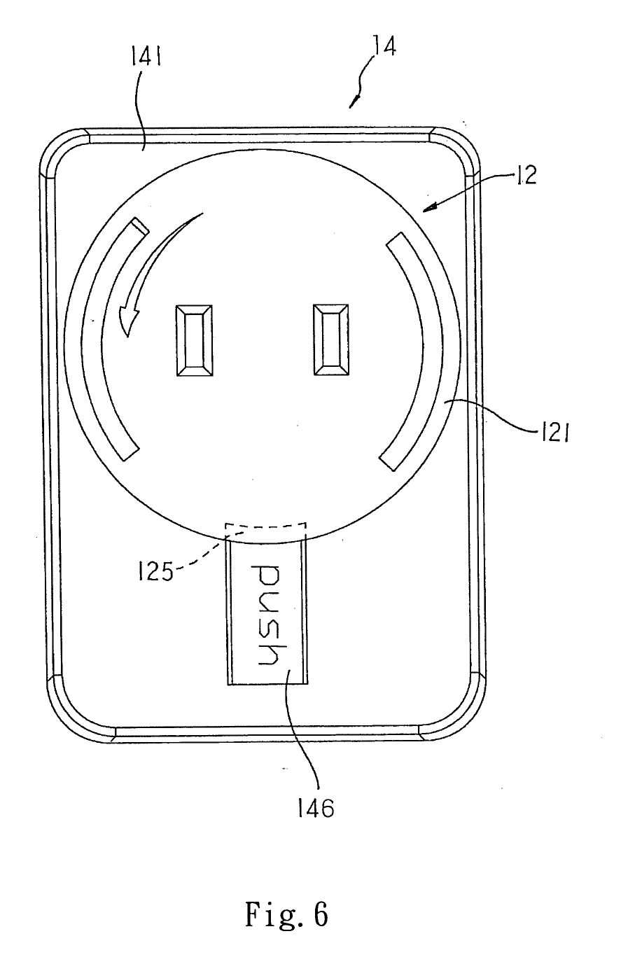

The power supply input end 10 may also include the first power cord 11, the plug 12 and a socket 14 as shown in FIGS. 4, 5 and 6. The socket 14 mainly includes an insulation case 141 which has a circular assembly trough 142 on one side, one or more notches 143 on one side of the assembly trough 142, and an arched slot 144 between the notches 143. The assembly trough 142 further has a contact reed 145 to be coupled with the plug 12 and a push element 146 close to the assembly trough 142 that is extended outside the surface of the notch 143 in normal conditions. The plug 12 mainly includes an insulation coupling portion 121, pins 122 located on the coupling portion 121 and a pad 123 beneath the coupling portion 121. The coupling portion 121 further has a flange 124 on the bottom insertable into the notch 143 and another notch 125 on one side to receive the push element 146. The pad 123 has an aperture 126 corresponding to the plug 12 to receive the contact reed 145 so that the socket 14 can be coupled alternately with the plug 12 of different specifications to increase the practicality.

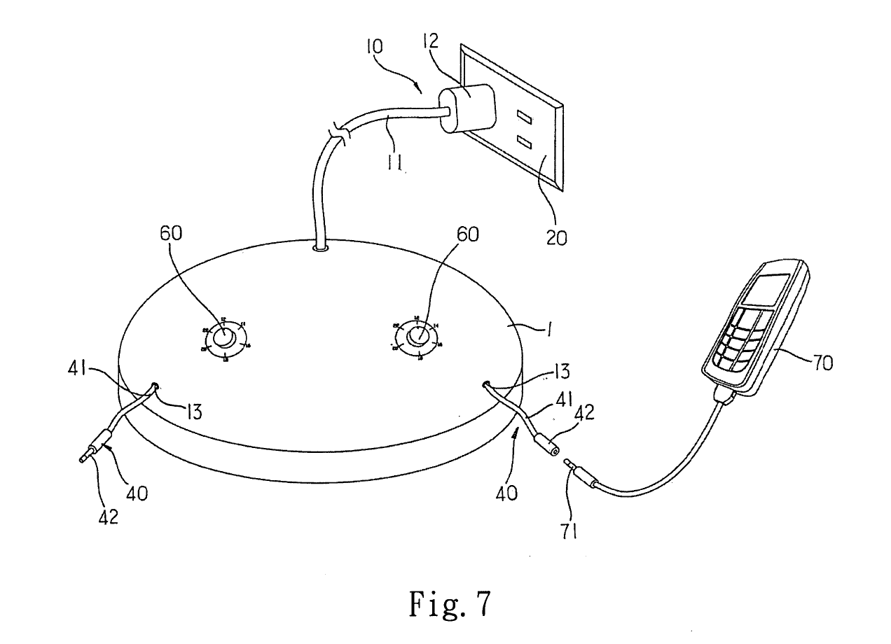

Referring to FIG. 7, the DC connector 42 at the power supply output ends 40 may be formed as desired to be coupled with a connector 71 of the electronic device 70 to deliver the transformed power supply to the electronic device 70. The DC connector 42 may be coupled with the connector 71 of varying shapes. As a result, the power supply apparatus can simultaneously provide power supply to different types of electronic devices 70.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A power supply apparatus, comprising at least:
a main body for holding all related elements;
at least one power supply input end to receive input of a power supply and transmit the power supply to a power conversion circuit;
the power conversion circuit located in the main body to transform the input power supply to a required power supply mode and deliver to power supply output ends;
at least two power supply output ends connectable to selected electronic devices to output the power supply to the corresponding electronic devices; and
a regulation means corresponding to each of the power supply output ends to adjust output power supply mode of the power supply output ends.

2. The power supply apparatus of claim 1, wherein the power supply input end is connected to a city power to receive AC power to the power conversion circuit.

3. The power supply apparatus of claim 1, wherein the power conversion circuit transforms AC power to DC power.

4. The power supply apparatus of claim 1, wherein each of the power supply output ends includes a second power cord and a DC connector.

5. The power supply apparatus of claim 1, wherein the power supply input end includes a first power cord, a socket and a plug.

6. The power supply apparatus of claim 5, wherein the socket includes an insulation case which has a circular assembly trough, at least one notch on one side of the assembly trough, and an arched slot between the notch, the assembly trough further having a contact reed to be coupled with the plug and a push element close to the assembly trough that is extended outside the surface of the notch in normal conditions, the plug including an insulation coupling portion, pins located on the coupling portion and a pad beneath the coupling portion, the coupling portion further having a flange on the bottom insertable into the notch and another notch on one side to receive the push element, the pad having an aperture corresponding to the plug to receive the contact reed.

7. The power supply apparatus of claim 4, wherein the second power cord is stored in the main body through a wire collector, the main body having an opening to allow the second power cord to be pulled out.

8. The power supply apparatus of claim 1, wherein the regulation means is a rotary knob.

9. The power supply apparatus of claim 1, wherein the regulation means regulates voltage values of the power supply output from the power supply output ends.
